(19) United States
(12) Patent Application Publication
(10) Pub. No.: US 2003/0118037 A1
(43) Pub. Date: Jun. 26, 2003

(54) Apparatus and method for interworking switching system network

(75) Inventor: Chung Ho Lee, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/260,343

(22) Filed: Oct. 1, 2002

(30) Foreign Application Priority Data
Dec. 22, 2001 (KR) 83484/2001

(51) Int. Cl. H04L 12/28

(52) U.S. Cl. 370/401

(57) ABSTRACT

An apparatus and method for interworking at least two switching system networks is disclosed. According to the disclosure, interworking is possible by processing a call process message using only one interworking function for both networks. Accordingly, there is no need for interworking protocol such as the ATM Inter-Network Interface (AINI). Preferably, the two networks are a Private Network to Network Interface (PNNI) type network and a B-ISDN User Part (B-ISUP) type network, and an interworking function is coupled to both a PNNI interface and a B-ISUP Interface. Preferably, addresses are registered at each of the interfaces and messages to be transmitted between networks are converted from an origination network protocol to a destination network protocol according to an interworking function table.

### BACKGROUND OF THE INVENTION

1. Field of the Invention

The present invention relates to a switching system network, and more particularly to an apparatus and method for interworking in a Private Network to Network Interface (PNNI) network and B-ISDN User Part (B-ISUP) network.

2. Background of the Related Art

Interworking between networks means connecting networks having different characteristics so as to provide service. In order to connect the differing networks, characteristics of each network are processed, thereby efficiently connecting the networks. The characteristics include attribute, performance, protocol, signal processing technology, address designation method, and so forth, of the networks. Interworking between networks mutually converts those characteristics, thereby providing services desired by a user over a different network.

Such interworking between communication networks can be realized by installing an interworking function (IWF) having interworking ability within a communication network or within separate equipment coupled to the network.

Referring to FIG. 1, in the related art, in order for a PNNI network and a B-ISUP network to interwork with each other, the AINI specification should be used. The interworking structure for the PNNI network and the B-ISUP network using the AINI is configured such that interworking switch 11A, 11B for interworking the PNNI network and B-ISUP, respectively, interworks using a AINI interface. Further, to each interworking switch 11A, 11B, local switches 12A, 12B are connected for matching users 13A, 13B through a User Network Interface (UNI).

The PNNI and B-ISUP are call process protocols for connecting an ATM switch with another ATM switch. More specifically, PNNI is a protocol for path designation and call control switched between the ATM switches. PNNI functions to dynamically determine an optimum transmission path depending on line troubles or congestion status. Namely, the PNNI uses a roundabout path or load distribution.

The path controlling function is similar to an Open Shortest Path First (OSPF) for an Internet Protocol (IP) communication network. For example, the path controlling function could divide the ATM network into several groups, then configure the groups in a layered structure, and control the path thereof.

B-ISUP is a protocol suggested by the International Telecommunication Union-Telecommunication Sector (ITU-T) for performing static routing. AINI is a call process protocol suggested by the ATM forum for connecting an ATM switch of the PNNI network and an ATM switch of the B-ISUP network, for performing interworking between the two different networks.

Further, the UNI is a call processing protocol suggested by the ATM forum for connecting an ATM switch with a subscriber (for example, a user).

More specifically, as shown in FIG. 2, the interworking switch 11A, which is for interworking with another network (B-ISUP network) from the PNNI network, and the interworking switch 11B, which is for interworking with another network (PNNI network) from the B-ISUP network, each establish the AINI port respectively, thereby connecting with each other. After that, a PNNI interface 22A and an AINI interface 23A, or an AINI interface 23B and a PNNI interface 22B, mutually interwork through an interworking apparatus IWF 21A, 21B, transmitting and receiving a call process message.

Also, the related art interworking between the PNNI network and the B-ISUP network is based on the AINI. Thus, a call process of the AINI is based on a call process message of the PNNI network side.

Therefore, for network interworking, a call process message received in the PNNI network is transferred to the B-ISUP through the AINI interface 23A of the interworking switch 11A located in the PNNI network side. The IWF 21B of the interworking switch 11B, located in the B-ISUP network side, receives the call process message through the AINI interface 22B. Then, message conversion is performed, as defined by the AINI specification in the same way as a SETUP message is converted to an Initial Address Message (IAM) used in the B-ISUP network side. The message is then transferred, as shown in FIG. 3a. After that, the call process message is transmitted to the B-ISUP network through the B-ISUP interface 23B.

Conversely, referring to FIG. 3b, a call process message received in the B-ISUP network is transferred to the IWF 21B through the B-ISUP interface 23B. The IWF 21B converts the received call process message from the B-ISUP network side into a message defined by the AINI specification in the same way as an IAM message is converted to a SETUP message used in the PNNI network side. The message is then transferred. After that, the call process message is transmitted to the PNNI network side through the ANNI interface 22B.

Here, FIG. 3a is a drawing illustrating an exemplarily call process procedure from the AINI interface 22B to the B-ISUP interface 23B upon network interworking between the PNNI network and the B-ISUP network. FIG. 3b is a drawing illustrating an exemplarily call process procedure from the B-ISUP interface 23B to the AINI interface 22B upon network interworking between the PNNI network and the B-ISUP network. More specifically, the messages shown in FIGS. 3a and 3b are call process messages used for establishing a connection, and FIGS. 3a and 3b show a procedure of a call process.

FIG. 3a and FIG. 3b are discriminated according to where a starting point of a call process is. FIG. 3a illustrates a process of establishing a connection initiated from the PNNI network for a call process and FIG. 3b illustrates a process of establishing a connection initiated from the B-ISUP network for a call process.

Also, in FIGS. 3a FIG. 3b, SETUP, CALL PROC, and CONN ate call process messages used for establishing a connection in the PNNI network and IAM, IAA, ACM (Address Complete Message), ANM (Answer Message) are call process messages used for establishing a connection in the B-ISUP network.

The interworking function between the PNNI network and the B-ISUP network using the foregoing related AINI protocol uses IWF 21A, 21B in the interworking switch 11A for supporting the PNNI interface 22A and the interworking switch 11B for supporting the B-ISUP interface 23B, respectively. This supports PNNI network interworking and B-ISUP network interworking between the two interworking switches 11A, 11B through the AINI.

The related art interworking between a PNNI network and a B-ISUP network has various problems. For example, for mutual interworking between the PNNI network and the B-ISUP network, an interworking switch for each network (i.e. two interworking switches) is necessary.

Additionally, in order for AINI communication upon network interworking, each interworking switch 11A, and 11B should not only support the AINI protocol but also establish separately one or more AINI port for interworking.

Furthermore, there is a problem of wasting resources, because resource for the relevant AINI port should be assigned. Namely, as shown in FIG. 2, a line for connecting one AINI interface with the other AINI interface is an actual physical line for connecting one ATM port with the other ATM port of each interworking switch. In order to use the line for AINI, the AINI interworking switch must establish a port for AINI, assign a bandwidth that will be used for the port, and store within the switch AINI related information such as the port or the bandwidth.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide an interworking apparatus and method in a switch network, which achieves interworking between the PNNI network and the B-ISUP network using an interworking function only, without using the AINI between the two networks. It is another object of the present invention to provide an interworking system and method that realizes network interworking without using the AINI protocol at a relevant interworking switch, saving resource that had been wasted in establishing an interworking port as well.

It is another object of the present invention to provide a system and method of interworking, where network interworking is possible by processing a call process message using only one interworking function for both networks, upon interworking between the PNNI network and the B-ISUP network of ATM (Asynchronous Transfer Mode) switch, without an interworking switch for supporting an interworking protocol such as AINI (ATM Inter-Network Interface).

In order to achieve at least the above objects in whole or in parts, there is provided an interworking apparatus in a switch network including a PNNI interface for matching a call process message from a PNNI network side; a B-ISUP interface for matching a call process message from a B-ISUP network side; a network interworking means for supporting connection of the PNNI interface with the B-ISUP interface, for mutually converting a call process message received through the PNNI interface or the B-ISUP interface using an interworking function.

In order to achieve at least the above objects in whole or in parts, there is further provided an interworking method in a switch network, including registering a routing address for a second network side at an interworking switch for interworking with a network operating with different protocol; registering the registered address as a first network address at a second interface; in case that a call process message is received from the first network, checking whether a called party address of the received call process message is previously registered as an address matching the first network side; in case that the called party address of the received call process message is registered as the address matching the first network side, converting the received call process message into a call process message using a second network interworking function, transmitting the same to the second network.

In order to achieve at least the above objects in whole or in parts, there is further provided an interworking method in a switch network, including registering a routing address for a second network side at an interworking switch for interworking with a network operating with different protocol; registering the registered address as a first network address at a second interface; in case that a call process message is received from a second network, checking whether a called party address of the received call process message is a local switch call or previously registered in a B-ISUP routing scenarios; in case that the received call process message is not the local switch call and not registered in the routing scenarios of the second network, converting the received call process message into a call process message using a first network interworking function, transmitting the same to the first network.

Therefore, the interworking apparatus and method in a switch network according to the preferred embodiments of the present invention interworks using one single interworking switch only, and without using the AINI between the PNNI network and the B-ISUP network. If, however, the AINI is used, an interworking port at each interworking switch need not to be established. The waste of resource is thus reduced. Further, interworking between the PNNI network and the B-ISUP network is possible with use of an interworking function only, without the AINI protocol supported by the interworking switch.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a drawing illustrating the related interworking structure between the PNNI network and the B-ISUP network using the AINI;

FIG. 2 is a drawing illustrating internal connection structure of each interworking switch in FIG. 1;

FIG. 3a is a drawing illustrating connection establishing process started from the PNNI network for a call process upon the related network interworking between the PNNI network and the B-ISUP network;

FIG. 3b is a drawing illustrating connection establishing process started from the B-ISUP network for a call process upon the related network interworking between the PNNI network and the B-ISUP network;

FIG. 4a is a drawing illustrating interworking structure between the PNNI network and the B-ISUP network using an interworking function of the preferred embodiments of the present invention;

FIG. 4b is a drawing illustrating internal connection structure of an interworking switch upon network interworking between the PNNI network and the B-ISUP network according to the preferred embodiments of the present invention;

FIG. 5a is a drawing illustrating connection establishing process started from the PNNI network for a call process upon network interworking between the PNNI network and the B-ISUP network according to a preferred embodiment of the present invention;

FIG. 5b is a drawing illustrating a connection establishing process started from the B-ISUP network for a call process upon network interworking between the PNNI network and the B-ISUP network according to the preferred embodiments of the present invention;

FIG. 6 is a drawing illustrating a parameter mapping relation for converting a SETUP message into an IAM message according to the preferred embodiments of the present invention;

FIG. 7 is a flowchart illustrating an interworking relation between the PNNI network and the B-ISUP network according to the preferred embodiments of the present invention.

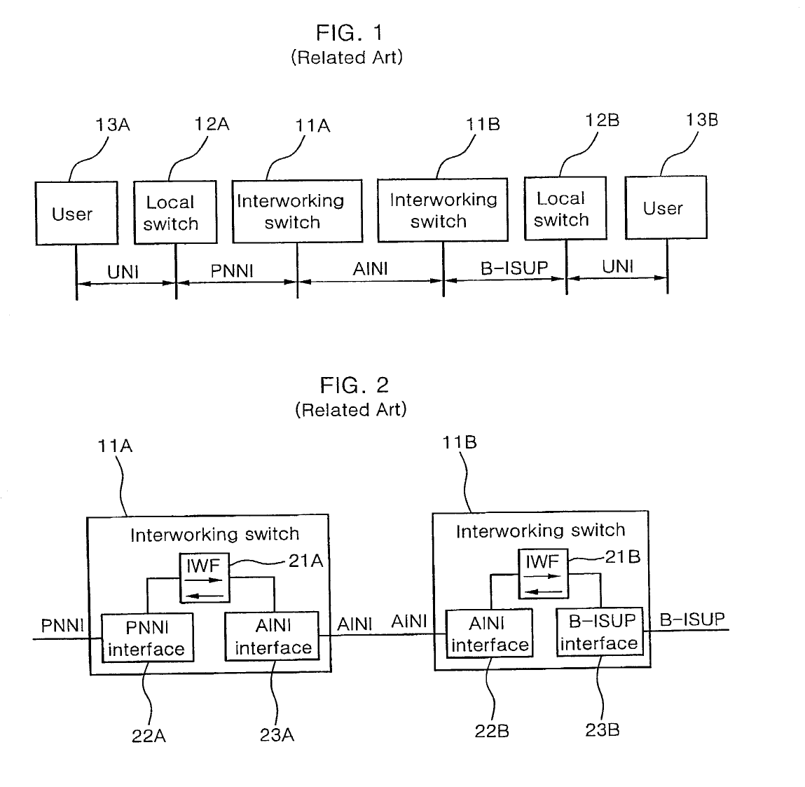

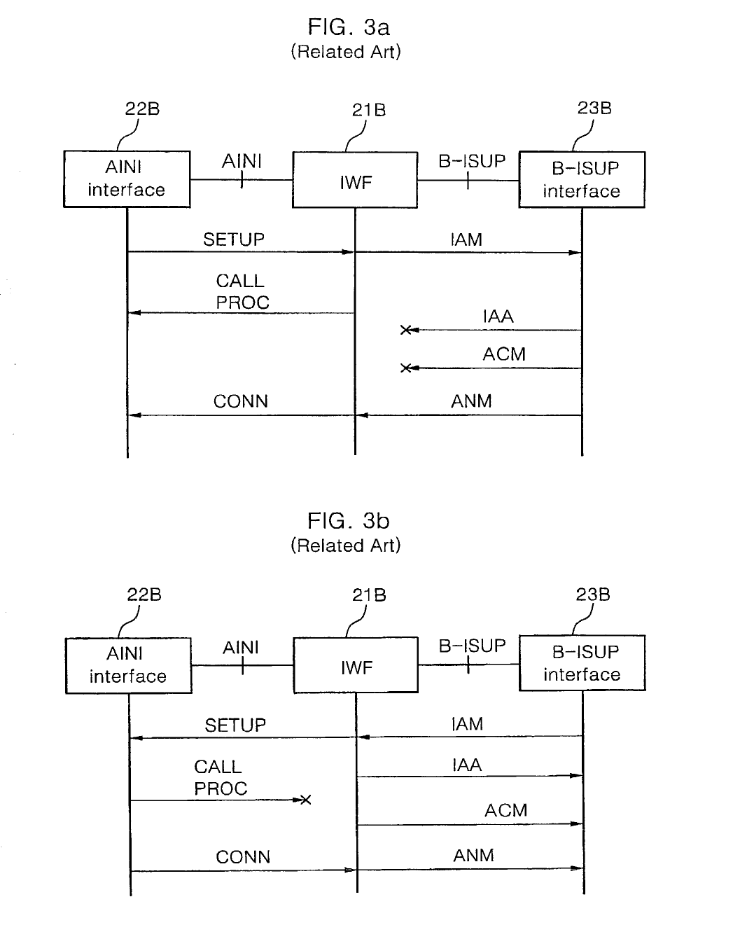

### DETAILED DESCRIPTION OF PREFERRED EMBODIMENTS

The following detailed description will present an interworking apparatus and method in a switch network according to a preferred embodiment of the invention with reference to the accompanying drawings.

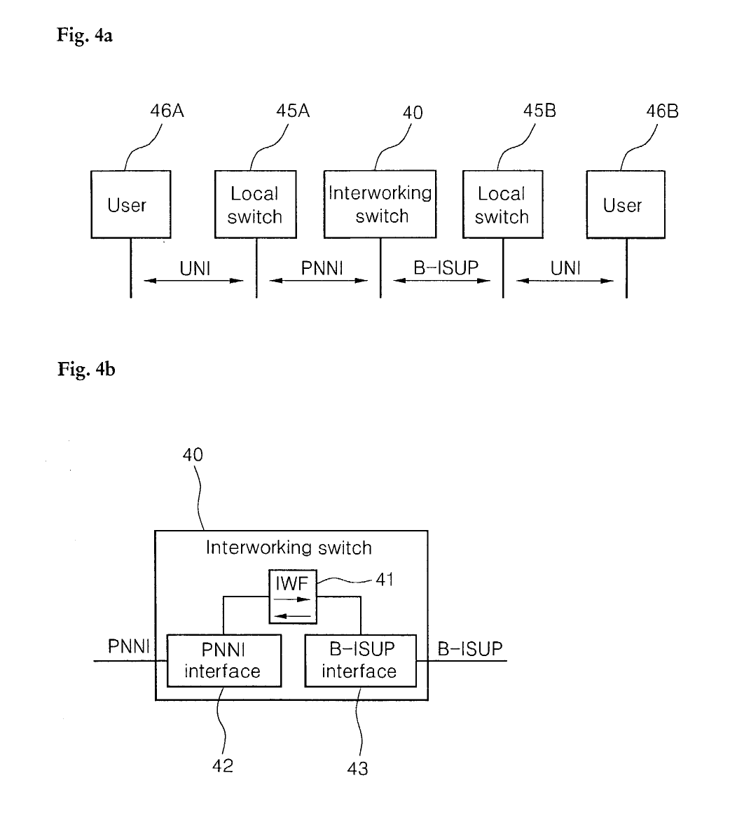

FIG. 4a is a drawing illustrating an interworking structure between the PNNI network and the B-ISUP network using an interworking function of the preferred embodiment. Referring to FIG. 4a, the PNNI network and B-ISUP network interwork using the interworking switch 40. Local switches 45A, 45B are coupled to the interworking switch 40 to match users 46A, 46B through a User Network Interface (UNI).

The interworking structure between the PNNI network and the B-ISUP network according to the preferred embodiment supports a connection of the PNNI interface 42 and the B-ISUP interface 43 within one single interworking switch 40. A call process message received in the PNNI network is transmitted to the B-ISUP network, and a call process message received in the B-ISUP network is transmitted to the PNNI network, respectively, using the interworking function at the IWF 41 (FIG. 4b) realized within the relevant interworking switch 40.

In such interworking structure between the PNNI network and the B-ISUP network, the interworking switch 40 preferably converts call process messages that should be transmitted to the B-ISUP network among call process messages received from the PNNI network through the PNNI interface 42 using B-ISUP interworking functions (referring to table 1 below) of the IWF 41. The converted message is then transmitted to the B-ISUP network through a B-ISUP interface 43. Conversely, the interworking switch 40 preferably converts call process messages that should be transmitted to the PNNI network among call process messages received from the B-ISUP network through the B-ISUP interface 43 using PNNI interworking functions (referring to table 2 below) of the IWF 41. The converted message is then transmitted to the PNNI network through the PNNI interface 42.

More specifically, messages that could be received to the PNNI interface from the PNNI network are those mentioned above such as SETUP, CALL PROC (Call Proceeding), and CONN (Connect).

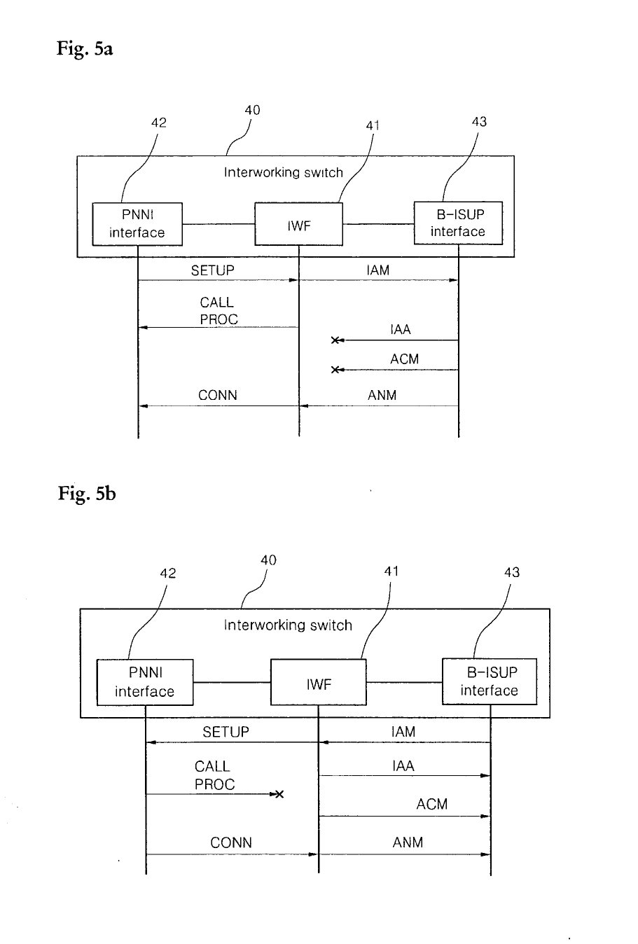

For example, as shown in FIG. 5a, when it is determined that a message should be transmitted to the B-ISUP network on the basis of a called ATM address included in a SETUP message received from the PNNI network, the SETUP message is converted into an IAM message through the B-ISUP interworking function, SETUPToIAM( ) (table 1), and then transmitted to the B-ISUP network.

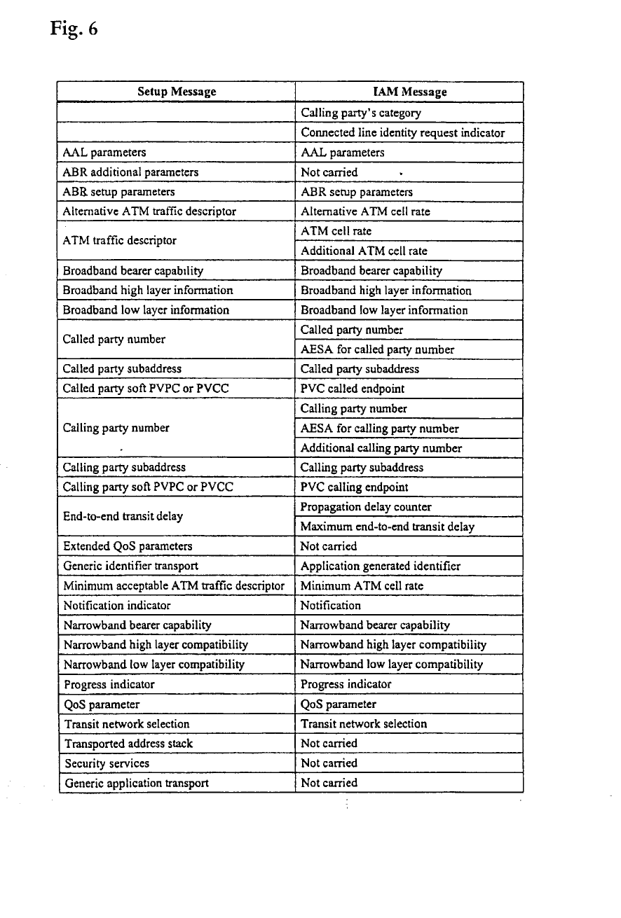

Parameters included in the SETUP message are mapped to parameters included in the IAM message, according to FIG. 6. Mapping rules and rules on how parameter values are converted are preferably the same as those in an AINI specification.

To perform interworking between the PNNI network and the B-ISUP network, addresses registered in a B-ISUP routing scenario defined for routing at the B-ISUP interface 43 are first converted into a Network Service Access Point (NSAP) form, as prescribed in E.164 for ISDN use. The converted messages are then registered as an exterior address for the PNNI interface 42.

Under such condition, upon receipt of the SETUP message through the PNNI interface 42 of the interworking switch 40, it is checked that a called party address of the received SETUP message is previously registered as the exterior address of the PNNI interface 42.

More specifically, in order to perform routing for the B-ISUP network, that is, to search for a path, it should be previously determined that a certain ATM address goes to a certain path. In order to determine such path, an ATM address is registered in the routing scenarios.

A form of the ATM address is registered in an address form of Native E.164. In the meantime, for an ATM address form for the PNNI network, an address form of NSAP E.164 is used.

Accordingly, in order to use an ATM address provided for routing in the B-ISUP network as a routing address of the PNNI network, the ATM address is converted and registered. For routing in the PNNI network, an address should be registered as an internal reachable address or exterior reachable address. The internal reachable address represents an address that includes subscriber information accommodated by a local switch itself within a PNNI routing range. The exterior reachable address represents an address derived from a switch having another protocol outside of the PNNI routing range.

Therefore, established addresses for routing in the B-ISUP network should preferably be converted into the NSAP E.164, an address form used for the PNNI network, and then registered as the exterior reachable address.

Here, the NSAP is an interface point between a user and service upon use of network service.

Related information is prescribed in a third hierarchy (network hierarchy) and a fourth hierarchy (transmission hierarchy) of the Open Systems Interconnection (OSI) basic reference model, and an address to identify such access point is a network service access point address, which is prescribed in ISO 8343 and ITU-T recommendations X.213.

An NSAP address form could adapt to variety of networks which need hierarchical address system. For example, it could adapt as X.121 for X.25 packet switch use, or E.164 for ISDN (Integrated Service Digital Network) use. An ATM address prescribed in a user-network interface (UNI) standard of the ATM forum is based on the NSAP address.

Referring again to FIG. 4b, if a called party address of the SETUP message is already registered as the exterior address of the PNNI interface 42, the IWF 41 converts the SETUP message into the IAM message using the B-ISUP interworking function. The IAM message is then transmitted to the B-ISUP network side through the B-ISUP interface 43.

Conversely, when the IAM message is received through the B-ISUP interface 43 of the interworking switch 40, it is determined whether a called party address of the received IAM message is a local switch call or previously registered in the B-ISUP routing scenarios.

At the moment, if the called party address of the received IAM message is not a local switch call and has not previously been registered in the B-ISUP routing scenarios, the IWF 41 converts the received IAM message into the SETUP message using the PNNI interworking function. The SETUP message is then transmitted to the PNNI network side through the PNNI interface 42.

A call process procedure upon network interworking between the PNNI network and the B-ISUP network according to the preferred embodiment is shown in FIGS. 5a and 5b. FIG. 5a is a drawing exemplarily illustrating a call process procedure from the PNNI interface 42 to the B-ISUP interface 43 within the interworking switch 40 upon network interworking between the PNNI network and the B-ISUP network, and FIG. 5b is a drawing exemplarily illustrating a call process procedure from the B-ISUP interface 43 to the PNNI interface 42 within the interworking switch 40 upon network interworking between the PNNI network and the B-ISUP network.

Also, in FIG. 5a, call process messages that should be transmitted to the B-ISUP network among call process messages received through the PNNI interface 42 are converted into the B-ISUP messages with use of the B-ISUP interworking functions shown in a table 1 below, then transmitted to the B-ISUP network side.

TABLE 1

| | | B-ISUP interworking |
|---|---|---|
| PNNI message | B-ISUP message | function |
| SETUP | IAM | SETUPToIAM() |
| CONNECT | ANM | ConnToANM() |
| RELEASE | REL | RelToREL() |
| RELEASE COMPLETE | REL | RelComToREL() |
| ADD PARTY | IAM | AddPtyToIAM() |
| ADD PARTY | ANM | AddPtyAckToANM() |
| ACKNOWLEDGE | | |
| ADD PARTY REJECT | REL | AddPtyRejToRel() |
| DROP PARTY | REL | DropPtyToRel() |

Conversely, in FIG. 5b, messages that should be transmitted to the PNNI network among message received through the B-ISUP interface 43, are converted into the PNNI messages with use of the PNNI interworking functions shown in a table 2 below, then transmitted to the PNNI network side.

TABLE 2

| | | PNNI interworking |
|---|---|---|
| B-ISUP message | PNNI message | function |
| IAM | SETUP | IAMToSETUP() |
| IAM | ADD PARTY | IAMToAddPty() |
| ANM (Answer Message) | CONNECT | ANMToConn() |
| ANM | ADD PARTY | ANMToAddPtyAck() |
| | ACKNOWLEDGE | |
| REL | RELEASE | RELToRel() |
| REL | DROP PARTY | RELToDropPty() |
| REL | ADD PARTY REJECT | RELToADDPtyRej() |
| IAR (Initial Address Reject) | RELEASE | IARToRel() |

Call process messages (IAA (Initial Address Acknowledgment), ACM, CALL PROC) not mentioned in the above tables 1 and 2 among call process messages given and taken upon network interworking between the PNNI network and the B-ISUP network of the preferred embodiment, are ignored without performing message conversion through the interworking function. A call process procedure for, and a message conversion of, those messages instead follow a procedure proposed in the AINI specification upon network interworking.

For example, when transmitting the SETUP message received from the PNNI network as the IAM message for the B-ISUP network side at the interworking switch, if a called party address of the received SETUP message has previously been registered in the exterior address of the PNNI interface 42, the IWF 41 converts the received SETUP message into the IAM message using the B-ISUP interworking function (SETUPToIAM( )). The converted message is then transmitted to the B-ISUP network side through the B-ISUP interface 43.

Conversely, when the IAM message is received through the B-ISUP interface 43 of the interworking switch 40, the interworking switch 40 checks whether a called party address of the received IAM message is the local switch call or previously registered in the B-ISUP routing scenarios.

If the called party address of the received IAM message is not the local switch call and has not been previously registered in the B-ISUP routing scenarios, IWF 41 converts the received IAM message into the SETUP message using the PNNI interworking function. The converted message is then transmitted to the PNNI network side through the PNNI interface 42.

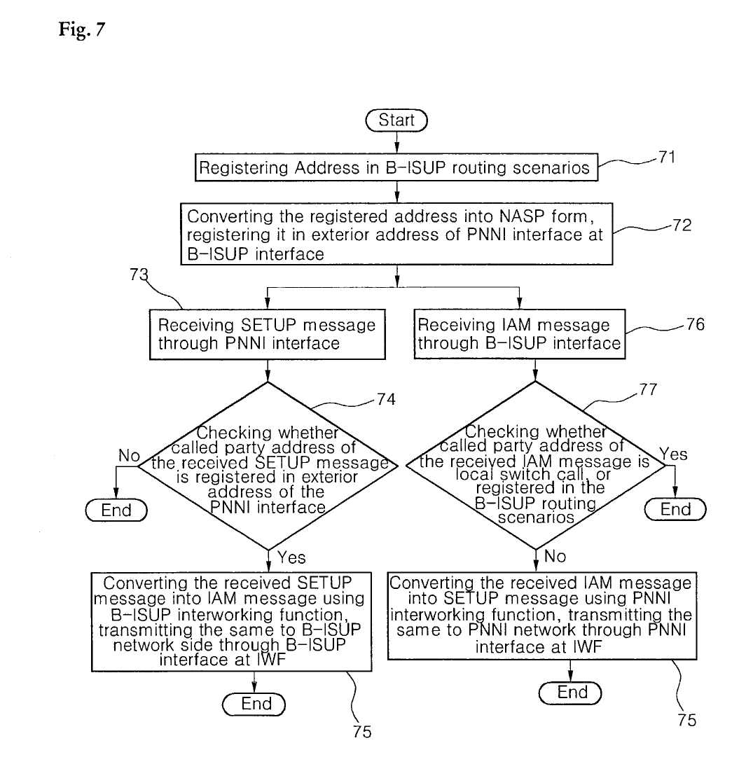

FIG. 7 is a flowchart illustrating the interworking relation between the PNNI network and the B-ISUP network. The process first includes registering an address in routing scenarios toward the B-ISUP network side at the interworking switch between the PNNI network and the B-ISUP network (Step 71).

Next, the above registered address is converted into NASP form, and registered as the exterior address of the PNNI interface at the B-ISUP interface (Step 72).

If the message is determined to be a SETUP message (a call process message) received from the PNNI network (Step 73), it is next determined whether a called party address of the received call process message is registered in the exterior address matching the PNNI network side (Step 74).

If it is determined that the called party address of the received call process message has previously been registered as the exterior address matching the PNNI network side, the received call process message is converted into the IAM message, which is a call process message used for the B-ISUP network, using the B-ISUP interworking function. Then, the IAM message is transmitted to the B-ISUP network through the B-ISUP interface (Step 75).

If, however, the received message is an IAM message from the B-ISUP network (Step 76), it is determined whether the called party address of the received call process message is the local switch call or registered in the B-ISUP routing scenarios (Step 77).

If the called party address of the received call process message is not the local switch call and has not previously been registered in the B-ISUP routing scenarios, the received call process message is converted into a SETUP message, which is a call process message used for the PNNI network, using the PNNI interworking function. Then, the SETUP message is transmitted to the PNNI network side (Step 78).

As is apparent from descriptions in FIG. 2, 3a/3b, 4a/4b, 5a/5b, messages sent and received between the PNNI network and the PNNI interface and between the B-ISUP network and the B-ISUP interface are not changed. Messages sent and received between the B-ISUP interface and the PNNI interface for interworking through the IWF, however, are different.

Namely, the PNNI switches call process messages, such as SETUP, CALL PROC, CONN, in its call process procedure, and establishes a connection, while the B-ISUP switches call process messages such as IAM, IAA, ACM, ANM in its call process procedure, and establishes connection.

Also, both the PNNI and the B-ISUP search for a path on the basis of previously established information. Thus, the PNNI performs dynamic routing to establish a connection, which searches for an optimum path on the basis of an ATM address included in a SETUP message, to send and receive a call process message, while the B-ISUP performs static routing to establish a connection, which searches for a previously established path on the basis of an ATM address included in an IAM message to send and receive a call process message.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An interworking apparatus in a switch system network, comprising:
a Private Network to Network Interface (PNNI) interface configured to match a call process message from a PNNI network side;
a B-ISDN User Part (B-ISUP) interface configured to match a call process message from a B-ISUP network side; and
a network interworking function configured to support a connection of the PNNI interface with the B-ISUP interface, for mutually converting a call process message received through one of the PNNI interface or the B-ISUP interface using an interworking function (IWF).

2. The apparatus of claim 1, wherein the PNNI interface, the B-ISUP interface, and the IWF comprise a single interworking switch for interworking in the PNNI network and the B-ISUP network.

3. The apparatus of claim 2, wherein the IWF is configured to convert call process messages that should be transmitted to the B-ISUP network among call process messages received from the PNNI network through the PNNI interface using a B-ISUP interworking function, and transmit the converted call process messages to the B-ISUP interface.

4. The apparatus of claim 2, wherein the IWF is configured to convert call process messages that should be transmitted to the PNNI network among call process messages received from the B-ISUP network through the B-ISUP interface by using a PNNI interworking function, and transmit the converted call process messages to the PNNI interface.

5. The apparatus of claim 1, wherein the connection between the PNNI interface and the B-ISUP interface is achieved without using an ATM Inter-Network Interface.

6. The apparatus of claim 1, wherein the network interworking function uses a prescribed conversion table to convert the call process message from a first protocol to a second protocol.

7. The apparatus of claim 1, wherein the network interworking function comprises a single interworking switch having two ports respectively directly coupled to the B-ISUP interface and the PNNI interface.

8. The apparatus of claim 1, wherein the network interworking function comprises means for directly coupling a PNNI network to a B-ISUP network.

9. The apparatus of claim 8, wherein the means for directly coupling the PNNI network to the B-ISUP network couples the networks without using an ATM inter-network interface protocol.

10. An interworking method in a switching system network, having first and second network sides, comprising:
registering a routing address for a first network side at an interworking switch for interworking with a network operating with different protocol;
registering the registered routing address as a network address at a first network side interface;
determining whether a called party address of a call process message received from a second network side has previously been registered as an address matching the second network side; and
if the called party address of the received call process message is registered as the address matching the second network side, converting the received call process message into a converted call process message using a first network interworking function, and transmitting the converted call process message to the first network.

11. The method of claim 10, wherein the first network side is a B-ISUP network.

12. The method of claim 10, wherein the second network side is a PNNI network.

13. The method of claim 10, wherein upon registering the address as an address of the first network side, an address including a subscriber information accommodated by a local switch for itself within a PNNI routing range and an address derived from a switch having another protocol outside of the PNNI routing range, could respectively be discriminated.

14. The method of claim 13, wherein the registered address is registered as an exterior address of the second network side interface.

15. An interworking method in a switching system network, comprising:
registering an address as a first registered address to a routing scenario for a B-ISUP (B-ISDN User Part) network at an interworking switch between a PNNI (Private Network to Network Interface) network and the B-ISUP network;
registering the first registered address as an exterior address of a PNNI interface at a B-ISUP interface;
checking whether a called party address of a call process message received from the PNNI network has previously been registered as the exterior address matching the PNNI network side; and
if the called party address of the received call process message has previously been registered as the exterior address matching the PNNI network side, converting the received call process message into a call process message used in the B-ISUP network, using a B-ISUP interworking function (IWF), and transmitting the call process message used in the B-ISUP network to the B-ISUP network.

16. The method of claim 15, wherein the first registered address is converted into a NASP form and registered as the exterior address of the PNNI interface at the B-ISUP interface.

17. The method of claim 15, wherein the call process message received from the PNNI network is a SETUP message.

18. The method of claim 15, wherein the call process message converted by the B-ISUP IWF and transmitted to the B-ISUP network is an Initial Address Message(IAM).

19. An interworking method in a switching system network, comprising:
registering an address to a routing scenario for a B-ISUP (B-ISDN User Part) network at an interworking switch as a first registered address for interworking in a PNNI (Private Network to Network Interface) network and the B-ISUP network;
registering the first registered address as an exterior address of a PNNI interface at a B-ISUP interface;
checking whether a called party address of a call process message received from the B-ISUP network is a local switch address or previously registered in the B-ISUP routing scenarios; and
if the called party address of the received call process message is not the local switch address and has not been previously registered in the B-ISUP routing scenarios, converting the received call process message into a call process message for the PNNI network using a PNNI interworking function (IWF), and transmitting the converted call process message to the PNNI network.

20. The method of claim 19, wherein the call process message received from the B-ISUP network is an IAM (Initial Address Message) message.

21. The method of claim 19, wherein the call process message converted by the PNNI IWF and used in the PNNI network is a SETUP message.
